(19) United States
(12) Patent Application Publication
(10) Pub. No.: US 2024/0051524 A1
(43) Pub. Date: Feb. 15, 2024

(54) CROWD-BASED MONITORING OF BRAKE OVERHEATING USING MULTIPLE MODALITIES

(71) Applicant: FORD GLOBAL TECHNOLOGIES, LLC, Dearborn, MI (US)

(72) Inventors: Mahmoud Y. Ghannam, Canton, MI (US); Aed M. Dudar, Canton, MI (US); Brian G. Bennie, Sterling Heights, MI (US); Frank L. Lollo, Plymouth, MI (US); Sai Prasanth Velusamy, Canton, MI (US)

(21) Appl. No.: 17/883,900

(22) Filed: Aug. 9, 2022

(51) Int. Cl. B60W 30/09; B60W 30/18; G06V 20/58; G06V 10/25; G06T 7/00

(52) U.S. Cl. CPC B60W 30/09; B60W 30/18163; G06V 20/584; G06V 10/25; G06T 7/0002; B60W 2554/402; B60W 2554/404; B60W 2720/12; B60W 2720/24; B60W 2555/20; G06T 2207/10048; G06T 2207/30252

(57) ABSTRACT

An apparatus in a host vehicle evaluates neighboring vehicles on a roadway for problems relating to braking performance. A plurality of remote sensors are configured to generate sensor data indicative of abnormalities of the brakes of the neighboring vehicles. A control circuit is configured to process the sensor data to identify a neighboring vehicle exhibiting an abnormality. A communication circuit wirelessly transmits a message to the neighboring vehicle conveying the abnormality. The host vehicle may include a driver assistance system responsive to the abnormality to initiate an evasive maneuver of the host vehicle in order to avoid a path of the neighboring vehicle which exhibits the abnormality.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to diagnostics of vehicle braking systems, and, more specifically, to inter-vehicle sharing of brake status information. Cars, trucks, and other transportation vehicles typically include various monitoring and diagnostic systems to detect and address any abnormalities of vehicle systems that may affect driving. For example, a tire pressure monitoring system (TPMS) detects the internal pressure of the tires and alerts a driver when the pressure drops below a certain threshold, but it does not monitor the external conditions of the tire. Some abnormalities are still often detected mostly by pre-drive visual inspection by a driver or technician.

At least some components of braking systems have been monitored, e.g., sensing hydraulic pressure, brake stroke, and other factors. With regard to potential overheating of braking components, however, a practical manner of temperature monitoring could prove useful. Whenever the brakes are overheated, they may experience “brake fade” in which braking power is reduced (at least until the temperature drops). Overheating can be caused by long periods of braking, such as when a large (e.g., commercial) truck descends a steep grade. Weather conditions, road conditions, or brake system issues including overly-worn or warped brake discs and wrongly installed brakes elements can also lead to overheating. Heat generated by tire friction may also contribute to brake overheating. It is desirable to detect abnormalities relating to overheating and/or the effects of overheating related to vehicle braking systems.

### SUMMARY OF THE INVENTION

The present invention detects abnormalities relating to overheating and/or the effects of overheating related to vehicle braking systems. To avoid potential difficulties associated with onboard sensing of overheating, sensor data is collected by vehicles other than one that experiences the abnormalities. By using an external viewpoint (i.e., outside of the monitored vehicle), a robust and efficient monitoring function is obtained. When sensor data indicates an abnormality, a message can be sent to the impacted vehicle (e.g., to enable automatic protection systems in the impacted vehicle or to accumulate diagnostic data). Moreover, drivers of the host (i.e., sensing) vehicle and/or the impacted vehicle can be informed, and when abnormalities are found in the impacted vehicle then the host vehicle or other vehicles can implement guided or automated evasive maneuvers.

In one aspect of the invention, a vehicle apparatus in a host vehicle evaluates neighboring vehicles. A plurality of remote sensors are configured to generate sensor data indicative of abnormalities of brakes of the neighboring vehicles. A control circuit is configured to process the sensor data to identify a neighboring vehicle exhibiting an abnormality. A communication circuit wirelessly transmits a message to the neighboring vehicle conveying the abnormality.

### BRIEF DESCRIPTION OF THE DRAWINGS

FIG. 1 is a schematic view of a plurality of vehicles moving on a roadway, with a host vehicle collecting remote data for neighboring vehicles.

FIG. 2 is a block diagram showing one preferred embodiment of a vehicle configured to perform the invention.

FIG. 3 is a flowchart of a first method of multi-modal monitoring for brake abnormalities of neighboring vehicles.

FIG. 4 is a block diagram depicting a detection modality using thermal imaging.

FIG. 5 is a block diagram depicting a detection modality using directional sound samples.

FIG. 6 is a block diagram depicting a detection modality using chemical composition sensing.

FIG. 7 is a block diagram showing a communication architecture for cloud-based services.

### DETAILED DESCRIPTION OF PREFERRED EMBODIMENTS

In certain embodiments, the invention may employ vehicle-mounted sensors to collect sensor data pertaining to neighboring vehicles in order to identify abnormalities associated with braking or tire status. For example, visible-light cameras and/or thermal cameras may provide images of regions of interest (e.g., wheels) within their field of view, and a controller analyzes the images to classify abnormalities. Overheating can be detected by thermal image analysis, recognition of smoke, and detection of chemical substances (using sniffers or smoke detectors). Images may also detect unstable wheel rotation, abnormal tire surface conditions, and excessive or erratic movements of brake system components. Types of smoke can be classified utilizing various algorithms, such as an air quality analyzer or video fire detection (VFD) algorithms. In some embodiments, a microphone or microphone array can record sounds of neighboring vehicles to detect sounds corresponding to predetermined abnormalities. For example, classification of squeaky sounds can be achieved by comparing recorded sounds against predefined criteria and thresholds.

By deploying the invention in a host vehicle, an improved perspective can be obtained in the monitoring of neighboring vehicles and data can be both used by the host vehicle to take action to avoid interactions with an abnormal vehicle and shared with one or more of the neighboring vehicles. In particular, data concerning an abnormal status (e.g., overheating or smoking in the vicinity of a wheel seen on a neighboring vehicle) is communicated to the vehicle exhibiting the abnormality via a wireless transmission. Existing communication channels can be used such as a vehicle-to-vehicle (V2V) communication network and/or a vehicle-to-everything (V2X) network.

The data being collected in real time can also be compiled and/or shared using a cloud server. Vehicle manufacturers, insurance carriers, road service providers, and others may be permitted to access the compiled data or just specific portions of the data concerning specific vehicles (e.g., a vehicle fleet), with or without compensation.

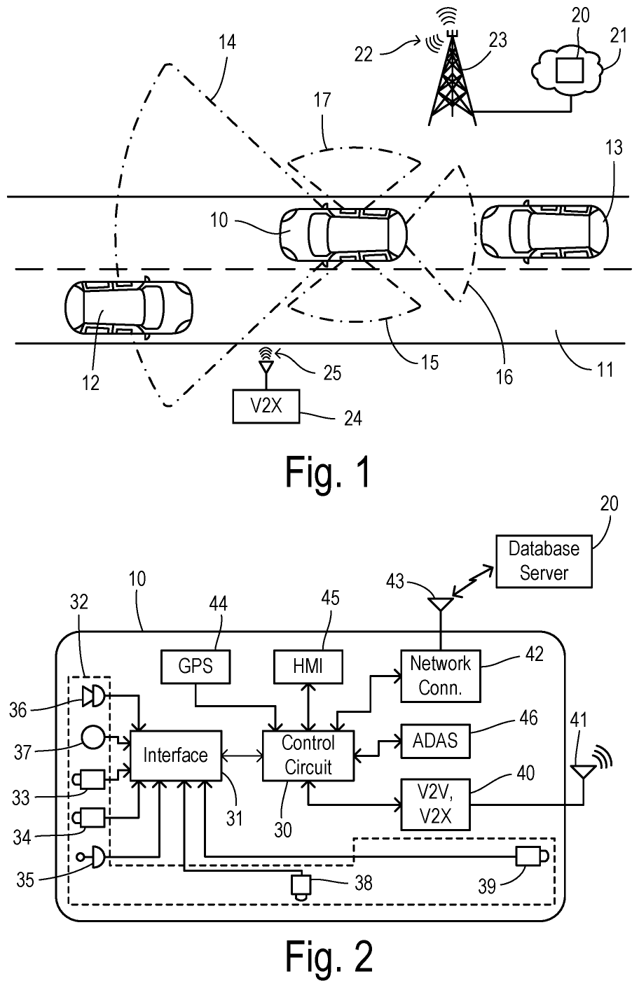

Referring to FIG. 1, a host vehicle 10 travels on a roadway 11 nearby neighboring vehicles 12 and 13. Host vehicle 10 includes a plurality of remote sensors of various modalities and having respective fields of view, such as fields of view 14, 15, 16, and 17 for monitoring neighboring vehicles 12 and 13. The remote sensors in host vehicle 10 are configured to generate sensor data indicative of abnormalities of braking systems of neighboring vehicles 12 and 13, for example. A control circuit in host vehicle 10 processes the sensor data to identify a neighboring vehicle which exhibits an abnormality. Vehicles 10, 12, and 13 may include transceivers for communicating wirelessly over a V2V service. When an abnormality is detected by the control circuit, then host vehicle 10 may transmit a message to the neighboring vehicle exhibiting the abnormality to inform it of specific details regarding the abnormality. Data concerning the abnormality can also be transmitted to a remote cloud server 21 located in a cloud network 21 using wireless signals 22 between host vehicle 10 and a cellular network 23 or using V2X signals 25 of a V2X transceiver 24. Depending upon the severity of an abnormality and the potential for the vehicle exhibiting the abnormality to interact with host vehicle 10 (e.g., due to loss of braking power or tire blow out), host vehicle 10 may also initiate evasive maneuvers.

FIG. 2 shows host vehicle 10 in greater detail. A control circuit 30 is coupled via an interface 31 to a plurality of remote sensors 32 which may include a visible light camera 33, an infrared camera 34, a radar transceiver 35, a directional microphone array 36, and/or a chemical sensor or sniffer 37 which may be oriented in a forward direction of host vehicle 10. Additional sensors setup for monitoring in different respective directions may include a camera 38, a camera 39, and others. Sensors 32 are configured to collect respective data signals based on sensed parameters present at neighboring vehicles which can reveal a status of the neighboring vehicles which relates to potential abnormal states (e.g., overheating of the environment around brake components).

When control circuit 30 detects an abnormal status of a neighboring vehicle, it will notify the affected vehicle and/or other vehicles or other service providers via a transceiver 40 with an antenna 41 using a V2V protocol or a V2X protocol. Additionally or alternatively, host vehicle 10 may include a network connection 42 and antenna 43 configured to share sensor data and/or abnormality status with a remote database in database server 20 (e.g., via a cellular data connection). Control circuit 30 may be connected to a satellite navigation device 44 such as a GPS receiver for determining geographic coordinates of host vehicle 10 in order to help identify neighboring vehicles, to look up roadway characteristics in a database such as number of lanes, and/or to report a location of the vehicle exhibiting the abnormality or of host vehicle 10.

In some embodiments, host vehicle 10 may additionally execute evasive maneuvers in an attempt to avoid a close approach to any vehicle having a brake system in an abnormal state. Therefore, a human machine interface 45 is coupled to control circuit 30 for advising the driver of specific changes in speed to make and/or steering changes to provide a greater separation distance from a predicted travel path of the neighboring vehicle exhibiting the abnormality. In some embodiments, an advanced driver assistance system (ADAS) 46 may receive and/or help plan out an evasive maneuver to be executed autonomously without direct driver control.

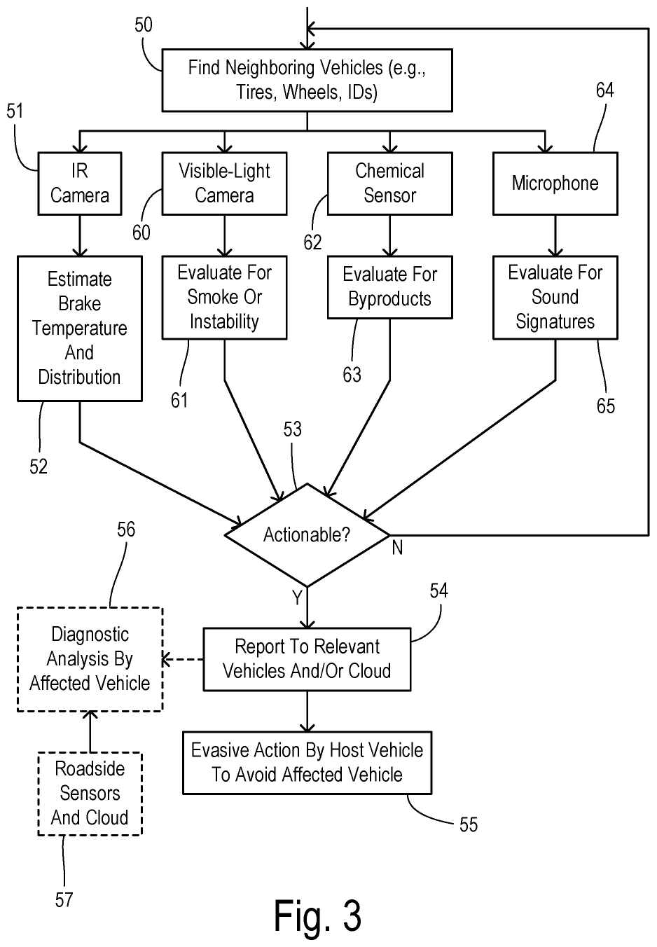

FIG. 3 shows a general method according to one embodiment of the invention wherein a control circuit (such as a general purpose processor in an electronic module) utilizes sensor data and/or wireless communication messages to find neighboring vehicles to be monitored. Finding the neighboring vehicles may preferably also include determining a region of interest within each vehicle for targeting the collection of sensor data. In a first detection modality, a thermal camera such as an infrared or near infrared camera obtains a thermal image in step 51 including a region of interest of a neighboring vehicle such as a wheel region. In step 52, the thermal image data is used to estimate a brake temperature and/or the distribution of temperatures around the braking components. In step 53, a determination is made whether the estimated temperatures are sufficiently high to warrant any responsive action. Depending upon the magnitude of any overheating, different actions corresponding to different temperature levels may be available. For example, when an overheating temperature indicates a potential for brake fade or other progressive deterioration, then the host vehicle may report the abnormal status in step 54 to relevant vehicles, including the vehicle exhibiting the abnormality and/or a data collection server in a remote cloud network. If the magnitude of overheating indicates a possibility of imminent loss of braking power then the host vehicle may take evasive action in step 55 to avoid the affected vehicle. The host vehicle may also communicate a need for evasive action to other nearby vehicles other than the one exhibiting the abnormality.

When an abnormality or associated sensor data are reported to the other vehicle affected by the abnormality, then the affected vehicle may conduct diagnostic analysis in step 56 and can adopt its own countermeasures. The diagnostic analysis in step 56 may also be supported by data collection in step 57 from roadside sensors and/or previously stored data from the cloud.

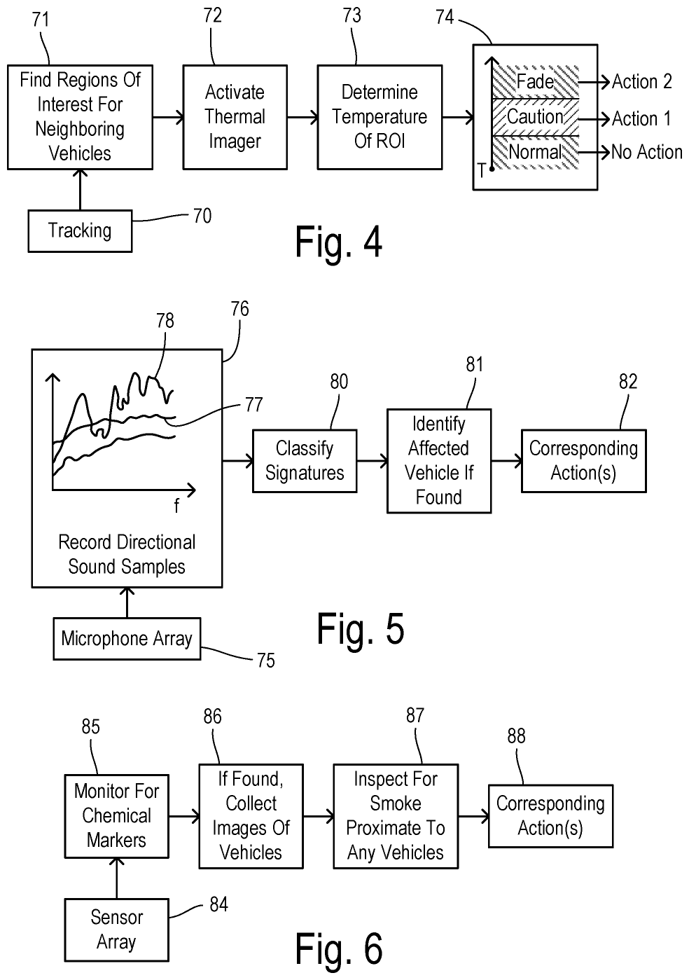

The thermal imaging modality is shown in greater detail in FIG. 4. Nearby vehicles are tracked in step 70. Particular interest may be paid to nearby commercial vehicles descending a steep grade, for example. Regions of interest of tracked vehicles are identified in step 71. In step 72, a thermal image is captured covering the region of interest. In step 73, portions of the thermal image corresponding to the region of interest are analyzed to infer a temperature of the brake components (e.g., disks and pads). The inferred temperature is compared with one or more thresholds in step 74 to determine an appropriate action. As shown, if the temperature T is less than a first threshold then temperature is considered to be normal and no action is taken. If temperature T is between the first threshold and a relatively higher second threshold then a first action labeled “Caution” is taken wherein slightly elevated temperature data is reported to the affected vehicle (as well as a central database for a fleet manager, if desired). When temperature T is greater than the second threshold, then an abnormality is identified comprising an elevated potential for a brake fade condition and a second action is taken wherein in addition to reporting the temperature data to the affected vehicle and/or the central database the host vehicle initiates any needed evasive action to reduce the chance of interaction with the affect vehicle if its brake performance is reduced.

Returning to FIG. 3, the method can use one or more different sensory modalities to identify abnormalities, either separately or simultaneously. After finding neighboring vehicles in step 50, another sensory modality which can be used is by collecting visible light images from a visible light camera in step 60. Visible light images can reveal smoke, tire deformation, and or mechanical vibrations or instability of various wheel or vehicle structures. Visible light images are evaluated in step 61 to detect any smoke or instability and then any smoke or instability sound are checked in step 53 to determine whether they are actionable.

In a third sensory modality, chemical sensing of substances related to overheating are used to evaluate or detect abnormalities. Thus, in step 62 a chemical sensor collects airborne substances known to be generated during overheating events. A chemical sensor array (CSA) can be used for detecting target materials such as specific byproduct molecules produced by overheated/burning brake pads. Sensor signals from the chemical sensor array are evaluated in step 63 to determine whether such byproducts are present and then a determination is made in step 53 to determine whether the level of chemical byproducts is actionable.

The chemical sensing modality is shown in greater detail in FIG. 6. In step 84, a chemical sensor array (CSA) is exposed to the ambient atmosphere around the host vehicle. The CSA can be a MEMS (micro-electromechanical system) device with cantilevers which respond to the different chemical byproducts. In step 85, the CSA is monitored for chemical markers associated with the chemical substances (byproducts) of interest. When a target substance is found, then images of the surrounding vehicles and/or other tracking information is collected in step 86. If the target substance is detected only for a time period when a particular neighboring vehicle is within a sufficiently close range, then it may be inferred that the source of the detection is that particular vehicle. Otherwise, images of the neighboring vehicles can be inspected in step 87 for any other indicators of a source of the chemical byproducts such as the presence of smoke in the air proximate to a particular vehicle. Depending on the detected chemicals and other factors (e.g., traffic density or relative speed and direction of motion), corresponding actions are taken in step 88 such as transmitting the detected abnormality to the particular vehicle.

Returning again to FIG. 3, another sensing modality is comprised of acoustic sound detection wherein noises generated by neighboring vehicles are analyzed using a microphone or microphone array in step 64. Sound signals recorded in step 54 are evaluated in step 65 to determine whether sounds are present which match predetermined sound signatures associated with brake abnormalities such as squeaking. In response to the evaluated sound signatures, a check is performed in step 53 to determine what actions if any should be taken.

The noise sensing modality is shown in greater detail in FIG. 5. Sound samples are sensed in step 75 by the microphone array and are recorded in step 76. A microphone array is useful for making the sound samples directional (i.e., differentiating sounds arriving from different directions). Spectral characteristics of noises generated by vehicles in ordinary operation may generally exhibit similar spectra such as shown by spectrum 77. A squealing sound of metal on metal or other sounds present during an overheating condition having brake fade may generate distinct spectra such as a spectrum 78. Advance empirical testing can be used to measure spectral signatures corresponding to different abnormalities. Sound signatures can also be established which utilize various audio properties to distinguish between different temperatures of the brake components generating the sounds. The resulting sound signatures are used in step 80 to classify the recorded directional sound samples in order to identify any abnormalities that may be present. In addition to abnormal states, sound signatures may be established which can distinguish other conditions such as levels of brake wear. In step 81, an affected vehicle which generates the abnormal noises is identified among the neighboring vehicles (e.g., based on a detected sound direction and the tracking of neighboring vehicles).

The multiple sensing modalities as shown in FIG. 3 can be utilized together continuously or in an adaptive manner. Data from different sensors can be fused in order to increase reliability of the detection of abnormalities. For example, after one modality generates an uncertain detection of smoke then data could be inspected from other modalities that overlap in time, and the other modalities might either verify or negate the existence of the suspected abnormality. In another example, the presence of an abnormality may be detectable using one modality but that modality may be unsuccessful in identifying which neighboring vehicle is the affected vehicle. Then, another modality could provide data enabling the identification to be made.

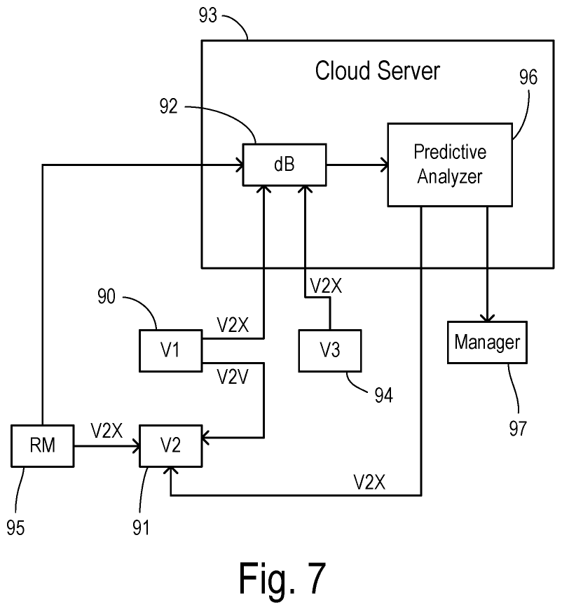

FIG. 7 shows a data flow diagram according to some embodiments of the invention. A first vehicle 90 is a host vehicle which monitors neighboring vehicles and detects potential or actual abnormalities concerning their braking/wheel/tire systems. When abnormal data is detected by first vehicle 90, a notification message is wirelessly transmitted to a second vehicle 91 which has been identified as the vehicle exhibiting the abnormality. The transmission can be conducted over a V2V network. In addition, first vehicle 90 may wireless transmit a notification message to a central database 92 in a cloud server 93 including the same data (e.g., identification of an abnormality and/or the sensor data upon which the detection is based) along with an identification of the vehicle which exhibits the abnormality. Such identification can be obtained using recognition of a license plate of the affected vehicle or obtained by vehicle 90 from vehicle 91 over the V2V communication link.

A third vehicle 94 is also shown which is configured to monitor neighboring vehicles and detect potential or actual abnormalities concerning their braking/wheel/tire systems. Third vehicle 94 may also generate sensor data corresponding to second vehicle 91 when it is in close enough proximity. When it detects an abnormality for vehicle 91 then it may send a corresponding notification message to database 92 even if it is unable to send a message to vehicle 91 (e.g., due to it moving out of range). Additional sensors may be installed at fixed locations (e.g., along a roadside or at a truck weigh station or rest stop) such as a remote monitor 95 which can detect abnormalities and then send wireless messages to vehicle 91 (over V2V) and/or to database 92 (over any data link).

Using data compiled in database 92, cloud server 93 may also use a predictive analyzer 96 which can accumulate data relevant to vehicle 91 over a greater length of time. Predictive analyzer 96 can determine an estimate of the likelihood of vehicle 91 experiencing a brake fade or other abnormality. When the estimate is above a predetermined likelihood then predictive analyzer 96 may send a corresponding message to vehicle 91 (over V2X) or to a fleet manager 97 which can flag vehicle 91 for corrective maintenance or other countermeasures.

What is claimed is:

1. Vehicle apparatus in a host vehicle for evaluating neighboring vehicles, comprising:
a plurality of remote sensors configured to generate sensor data indicative of abnormalities of brakes of the neighboring vehicles;
a control circuit configured to process the sensor data to identify a neighboring vehicle exhibiting an abnormality; and
a communication circuit wirelessly transmitting a message to the neighboring vehicle conveying the abnormality.

2. The vehicle of claim 1 further comprising:
a driver assistance system responsive to the abnormality to initiate an evasive maneuver of the host vehicle in order to avoid a path of the neighboring vehicle which exhibits the abnormality.

3. The vehicle of claim 2 wherein the evasive maneuver is comprised of a change of speed of the host vehicle.

4. The vehicle of claim 2 wherein the evasive maneuver is comprised of a change of lane of a roadway on which the host vehicle drives.

5. The vehicle of claim 1 wherein the remote sensors comprise a thermal imager, wherein the control circuit delineates a region of interest relative to at least one of the neighboring vehicles, wherein the control circuit determines a brake temperature according to a thermal image of the region of interest, and wherein the control circuit compares the brake temperature to at least one temperature threshold to determine whether to convey the message.

6. The vehicle of claim 5 wherein the control circuit compares the brake temperature to a plurality of temperature ranges defined in part according to the at least one temperature threshold in order to select from a plurality of corresponding actions, and wherein the corresponding actions include transmitting the message.

7. The vehicle of claim 1 wherein the remote sensors comprise a microphone array, wherein the control circuit compares recorded sound samples from the microphone array to a plurality of sound signatures corresponding to predetermined brake abnormalities to classify the recorded sound samples, and wherein the control circuit selects from a plurality of corresponding actions according to the classifying, and wherein the corresponding actions include transmitting the message.

8. The vehicle of claim 1 wherein the remote sensors comprise a chemical sensor for generating indications of a presence of predetermined chemicals as the abnormality, wherein the control circuit associates a selected one of the neighboring vehicles with the presence of at least one of the predetermined chemicals to receive the transmitted message.

9. The vehicle of claim 1 wherein the remote sensors comprise a visible-light camera, and wherein the sensor data includes visible images of smoke or instabilities associated by the control circuit with the neighboring vehicle exhibiting the abnormality.

10. The vehicle of claim 1 wherein the communication circuit is further configured to transmit a notification of the abnormality and an identification of the neighboring vehicle exhibiting the abnormality to a cloud server.

11. A method of evaluating brake abnormalities in vehicles, comprising the steps of:
generating sensor data relating to neighboring vehicles using a plurality of remote sensors in a host vehicle, wherein the sensor data is indicative of a status of brakes in the neighboring vehicles;
comparing the sensor data to predetermined criteria for detecting an abnormality of the status of the brakes;
identifying a neighboring vehicle exhibiting an abnormality; and
wirelessly transmitting a message to the neighboring vehicle conveying the detected abnormality.

12. The method of claim 11 further comprising the step of:
initiating an evasive maneuver of the host vehicle in responsive to the detected abnormality in order to avoid a path of the neighboring vehicle which exhibits the abnormality.

13. The method of claim 12 wherein the evasive maneuver is comprised of a change of speed of the host vehicle.

14. The method of claim 12 wherein the evasive maneuver is comprised of a change of lane of a roadway on which the host vehicle drives.

15. The method of claim 11 wherein the sensor data is comprised of a thermal image, the method further comprising the steps of:
delineating a region of interest relative to a neighboring vehicle; and
determining a brake temperature according to the thermal image of the region of interest;
wherein the comparison step compares the brake temperature to at least one temperature threshold to determine whether to convey the message.

16. The method of claim 15 wherein the comparison step compares the brake temperature to a plurality of temperature ranges defined in part according to the at least one temperature threshold in order to select from a plurality of corresponding actions, and wherein the corresponding actions include transmitting the message and initiating an evasive maneuver.

17. The method of claim 11 wherein the sensor data is comprised of recorded sound samples, wherein the comparing step compares the recorded sound samples to a plurality of sound signatures corresponding to predetermined brake abnormalities to classify the recorded sound samples.

18. The method of claim 11 wherein the sensor data is comprised indications of a presence of predetermined chemicals each associated with a respective abnormality.

19. The method of claim 11 wherein the sensor data is comprised of visible-light images, and wherein the comparison step detects smoke or instabilities associated with the neighboring vehicle exhibiting the abnormality.

20. The method of claim 11 further comprising the step of transmitting a notification of the abnormality and an identification of the neighboring vehicle exhibiting the abnormality to a cloud server.
